(19) United States
(12) Patent Application Publication
(10) Pub. No.: US 2025/0105332 A1
(43) Pub. Date: Mar. 27, 2025

(54) SECONDARY BATTERY

(71) Applicant: TOYOTA JIDOSHA KABUSHIKI KAISHA, Toyota-shi (JP)

(72) Inventor: Tomoya HAYASHI, Nagoya (JP)

(73) Assignee: TOYOTA JIDOSHA KABUSHIKI KAISHA, Toyota-shi (JP)

(21) Appl. No.: 18/643,173

(22) Filed: Apr. 23, 2024

(30) Foreign Application Priority Data
Sep. 27, 2023 (JP) 2023-166200

(51) Int. Cl. H01M 10/04; H01M 50/103; H01M 50/538

(52) U.S. Cl. CPC H01M 10/0431; H01M 50/103; H01M 50/538

(57) ABSTRACT

The secondary battery includes a cathode plate in which a cathode active material layer is formed except a cathode current collector foil exposed portion along one long side of the positive current collecting foil, an anode plate in which an anode active material layer is formed except an anode current collector foil exposed portion along one long side of the anode current collector foil, a battery case for accommodating the wound electrode body and an electrolytic solution, a cathode current collector terminal electrically connected to a cathode foil combining portion in which the cathode current collector foil exposed portion is summarized, a region excluding the positive current collecting foil portion of the cathode current collector foil exposed portion, and at least one of the regions excluding the anode foil combining portion comprise an insulating layer formed.

### CROSS-REFERENCE TO RELATED APPLICATION

This application claims priority to Japanese Patent Application No. 2023-166200 filed on Sep. 27, 2023, incorporated herein by reference in its entirety.

### BACKGROUND

### 1. Technical Field

The present disclosure relates to a secondary battery.

### 2. Description of Related Art

Japanese Unexamined Patent Application Publication No. 2023-089639 (JP 2023-089639 A) discloses a secondary battery including a wound electrode body in which a cathode plate and an anode plate are wound with a separator interposed therebetween. The cathode plate projects from the separator on a first side in a winding axis direction, and a cathode current collector is joined to that portion. The outermost periphery of the anode plate is wound on an outer peripheral side with respect to the outermost periphery of the cathode plate. A portion of a separator wound on an outer peripheral side with respect to the outermost periphery of the anode plate extends to the first side, and is retained at the portion where the cathode current collector and the cathode plate are joined. Thus, entry of foreign matter into a gap between the cathode plate and the anode plate on the outermost periphery is reduced.

### SUMMARY

In JP 2023-089639 A, a short circuit in the gap between the cathode plate and the anode plate on the outermost periphery can be suppressed by extending the separator on the outermost periphery and joining the separator together with the cathode plate to the cathode current collector. In JP 2023-089639 A, however, the impregnation characteristic of the wound electrode body at the time of injecting an electrolytic solution is not taken into consideration, and the electrolytic solution impregnation characteristic may decrease.

The present disclosure has been made in view of such a problem. An object of the present disclosure is to provide a secondary battery in which a short circuit in a gap between a cathode plate and an anode plate with a separator interposed therebetween can be suppressed and a decrease in electrolytic solution impregnation characteristic of a wound electrode body can be suppressed.

A secondary battery according to an aspect includes:
a wound electrode body in which a cathode plate including a cathode active material layer except for cathode current collector foil exposed portions extending along one long side of a band-shaped cathode current collector foil and an anode plate including an anode active material layer except for anode current collector foil exposed portions extending along one long side of a band-shaped anode current collector foil are wound with a band-shaped separator interposed between the cathode plate and the anode plate;
a battery case that houses the wound electrode body and an electrolytic solution; a cathode current collector terminal electrically connected to a cathode foil combining portion where the cathode current collector foil exposed portions are combined;
an anode current collector terminal electrically connected to an anode foil combining portion where the anode current collector foil exposed portions are combined; and
insulating layers provided in at least one of regions of the cathode current collector foil exposed portions except the cathode foil combining portion and regions of the anode current collector foil exposed portions except the anode foil combining portion.

According to the present disclosure, it is possible to suppress the short circuit in the gap between the cathode plate and the anode plate with the separator interposed therebetween and the decrease in the electrolytic solution impregnation characteristic of the wound electrode body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outer shape of a secondary battery according to an embodiment;

FIG. 2 is a diagram illustrating an internal configuration of the secondary battery of FIG. 1;

FIG. 3 is an exploded view illustrating a configuration of a wound electrode body;

FIG. 4 is a side view of the wound electrode body;

FIG. 5 is an enlarged view of a portion of the cross-section of the wound electrode body at cutting line V of FIG. 4; and

FIG. 6 is an enlarged view of a part of a cross section of the wound electrode body in the cutting line VI of FIG. 4.

### DETAILED DESCRIPTION OF EMBODIMENTS

Hereinafter, the present embodiment will be described with reference to the drawings. Note that the following embodiments are not intended to limit the technology disclosed herein. For clarity of explanation, the following description and the drawings are omitted and simplified as appropriate. The dimensional relationship (length, width, thickness, etc.) in each drawing does not reflect the actual dimensional relationship. In the drawings, the same elements are denoted by the same reference numerals, and redundant descriptions are omitted as necessary.

Embodiments described herein relate generally to a secondary battery used as a power source for driving a battery electric vehicle or the like. In the present specification, the term “secondary battery” refers to a general electric storage device that can be repeatedly charged and discharged, and includes an electric storage element such as a so-called storage battery or an electric double layer capacitor. Here, an embodiment will be described in detail by taking a flat-square lithium ion secondary battery as an example. “Lithium secondary battery” refers to a secondary battery in which charge and discharge are realized by the transfer of charge caused by lithium ions between positive and negative electrodes using lithium ions as charge carriers.

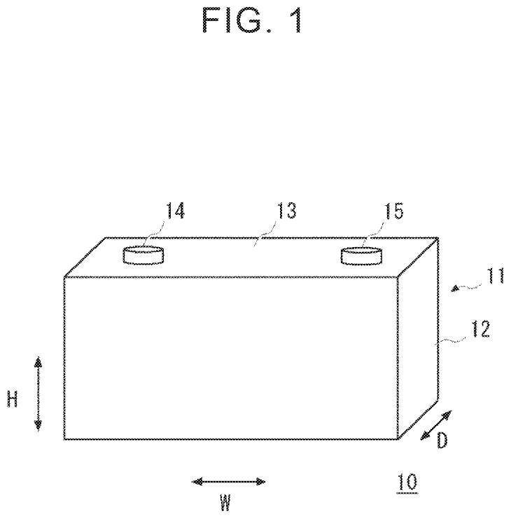

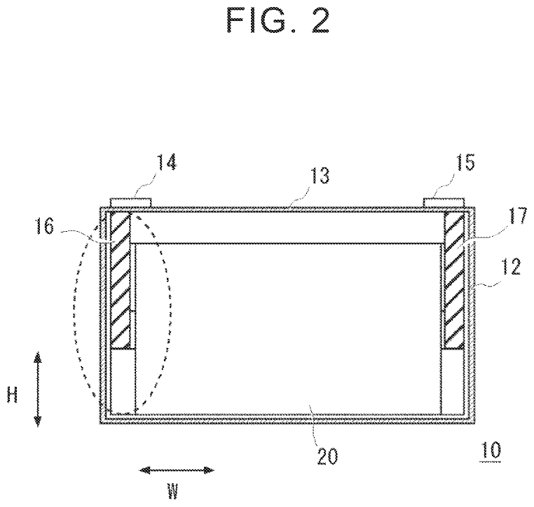

FIG. 1 is a diagram illustrating an outer shape of a secondary battery 10 according to an embodiment. FIG. 2 is a diagram for explaining an internal configuration of the secondary battery 10 of FIG. 1. As shown in FIGS. 1 and 2, the secondary battery 10 has a structure in which a wound electrode body 20 and an electrolytic solution (not shown) are accommodated in a battery case 11. W in the drawing indicates the width direction of the battery case 11. H in the drawing indicates the height direction of the battery case 11. A direction orthogonal to the width direction W and the height direction H is defined as a thickness direction D of the battery case 11. Note that these directions do not limit the installation mode of the secondary battery 10.

The battery case 11 is a rectangular container having an outer shape of a substantially rectangular parallelepiped and having an internal space. As the battery case 11, for example, a light-weight and thermally conductive metallic material such as aluminum or stainless steel (SUS) is used. The battery case 11 includes a main body 12 having an opening opened upward, and a lid 13 for closing the opening. The main body 12 has a substantially rectangular bottom surface, a pair of wide surfaces, and a narrow surface disposed between the pair of wide surfaces. In FIG. 1, the pair of wide surfaces extend upward from the front end and the rear end of the bottom surface, respectively. Further, the pair of narrow surfaces extend upward from the left end and the right end of the bottom surface, respectively. The peripheral edge of the opening of the main body 12 and the outer edge of the lid 13 are laser-welded, and the battery case 11 is sealed.

The lid 13 of the battery case 11 is provided with a positive electrode external terminal 14 and a negative electrode external terminal 15. Further, the lid 13 is provided with a liquid injection port (not shown) for injecting an electrolytic solution. The liquid injection port may be provided between the positive electrode external terminal 14 and the negative electrode external terminal 15 of the lid 13, for example. As shown in FIG. 2, a portion of the positive electrode external terminal 14 and a portion of the negative electrode external terminal 15 are connected to the cathode current collector terminal 16 and the anode current collector terminal 17, respectively, inside the battery case 11.

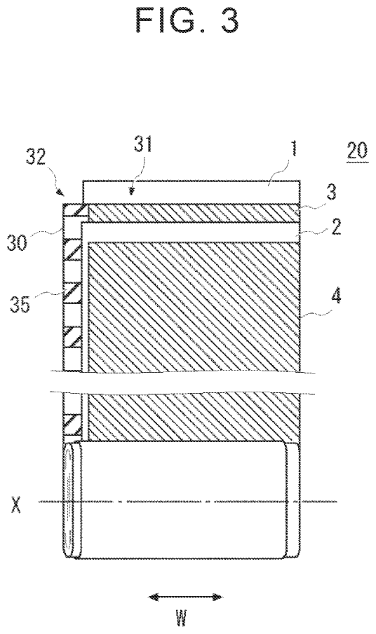

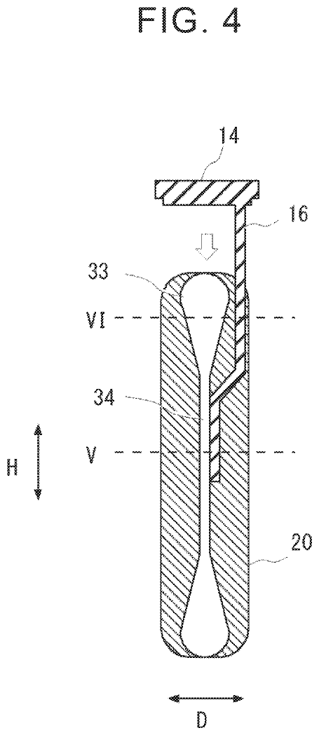

The wound electrode body 20 is accommodated in a space surrounded by the main body 12 and the lid 13. FIG. 3 is an exploded view illustrating a configuration of the wound electrode body 20. FIG. 4 is a side view of the wound electrode body 20. In FIG. 4, the side surface of the wound electrode body 20 on the side to which the cathode current collector terminal 16 is connected, which is indicated by a broken line in FIG. 3, is shown.

As shown in FIG. 3, the wound electrode body 20 includes a strip-shaped first separator 1, a second separator 2, a cathode plate 3, and an anode plate 4. A length direction of the first separator 1, the second separator 2, the cathode plate 3, and the anode plate 4 is defined as a long side direction, and a width direction is defined as a short side direction. The first separator 1, the cathode plate 3, the second separator 2, and the anode plate 4 are sequentially stacked with the long side direction aligned, and wound around the winding axis X. In the present embodiment, the direction of the winding axis X of the wound electrode body 20 corresponds to the width direction W of the secondary battery 10. As shown in FIG. 4, the cross section of the wound electrode body 20 has an oval shape.

The cathode plate 3 includes a cathode current collector foil 30 and a cathode active material layer 31. The cathode current collector foil 30 is a support member of the cathode active material layer 31, and is a conductive member for extracting electric charges from the cathode active material layer 31. A cathode current collector foil exposed portion 32 is provided in a region along one long side of the strip-shaped cathode current collector foil 30. The cathode active material layer 31 is formed in a region other than the cathode current collector foil exposed portion 32 on the cathode current collector foil 30. The cathode active material layer 31 is formed in a strip shape along the other long side of the cathode current collector foil 30. The cathode active material layer 31 may be formed on one surface or both surfaces of the cathode current collector foil 30. Here, the cathode active material layer 31 is formed on both surfaces of the cathode current collector foil 30. That is, the cathode plate 3 is long, and the wide cathode active material layer 31 and the narrow cathode current collector foil exposed portion 32 are arranged in the width direction.

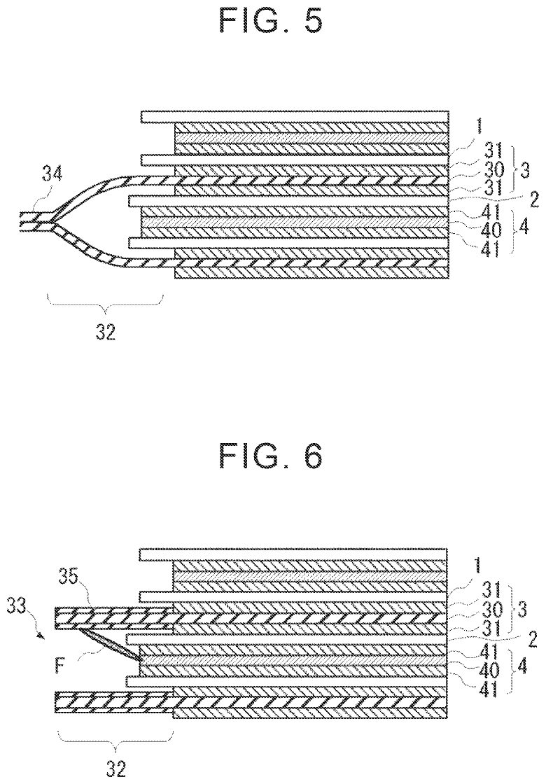

Although not shown in FIG. 3, the anode plate 4 includes an anode current collector foil 40 and an anode active material layer 41 (see FIG. 5). The anode current collector foil 40 is a support member of the anode active material layer 41, and is a conductive member for extracting electric charges from the anode active material layer 41. an anode current collector foil exposed portion is provided in a region along one long side of the strip-shaped anode current collector foil 40. The anode active material layer 41 is formed in a region on the anode current collector foil 40 except for the anode current collector foil exposed portion. The anode active material layer 41 is formed in a strip shape along the other long side of the anode current collector foil 40. The anode active material layer 41 may be formed on one surface or both surfaces of the anode current collector foil 40. Here, it is assumed that the anode active material layer 41 is formed on both surfaces of the anode current collector foil 40. That is, the anode plate 4 is long, and the anode active material layer 41 having a wide width and the anode current collector foil exposed portion having a narrow width are arranged in the width direction.

The members and materials constituting the secondary battery 10 are the same as those used in a widely known lithium ion secondary battery, and are not particularly limited. Examples of members and materials constituting the secondary battery 10 are shown below.

Examples of the cathode current collector foil 30 constituting the cathode plate 3 include aluminum (including an aluminum alloy) foil. Examples of cathode active materials included in the cathode active material layer 31 include lithium transition metal oxide (e.g., LiNi_{1/3}Co_{1/3}Mn_{1/3}O₂, LiNiO₂, LiCoO₂, LiFeO₂, LiMn₂O₄, LiNi_{0.5}Mn_{1.5}O₄, etc.), lithium transition metal phosphide compounds (e.g., LiFePO₄, etc.). The cathode active material layer 31 may include components other than the active material, for example, a conductive material, a binder, and the like. As the conductive material, for example, carbon black such as acetylene black (AB) or other carbon materials (such as graphite) may be used. As the binder, for example, polyvinylidene fluoride (PVdF) or the like can be used.

The anode current collector foil 40 constituting the anode plate 4 is, for example, a copper foil. As the negative electrode active material contained in the anode active material layer 41, for example, a carbon material such as graphite, hard carbon, or soft carbon may be used. When graphite is used as the negative electrode active material, the negative electrode active material may be natural graphite or artificial graphite, or may be coated with an amorphous carbon material. The anode active material layer 41 may contain components other than the active material, such as a binder and a thickener. As the binder, for example, styrene-butadiene rubber (SBR) or the like can be used. As the thickener, for example, carboxymethylcellulose (CMC) or the like can be used.

The first separator 1 and the second separator 2 insulate the cathode plate 3 and the anode plate 4, and provide a transfer path of charge carriers between the cathode active material layer 31 and the anode active material layer 41. As the first separator 1 and the second separator 2, porous sheets (films) made of polyolefin such as polyethylene (PE) and polypropylene (PP) may be used. Such a porous sheet may have a single-layer structure or a laminated structure of two or more layers (for example, a three-layer structure in which PP layers are laminated on both surfaces of a PE layer). Heat resistant layers (HRL) may be provided on the first separator 1 and the second separator 2.

The electrolytic solution typically comprises a non-aqueous solvent and a supporting salt. As the non-aqueous solvent, a known solvent used as a non-aqueous solvent of an electrolytic solution for a lithium ion secondary battery can be used. Examples of the non-aqueous solvent include carbonates, ethers, esters, nitriles, sulfones, and lactones. Examples of carbonates include ethylene carbonate (EC), propylene carbonate (PC), diethyl carbonate (DEC), dimethyl carbonate (DMC), ethyl methyl carbonate (EMC). Such a non-aqueous solvent may be used singly or in combination of two or more.

As the support salt, for example, lithium salt such as LiPF₆, LiBF₄, and LiClO₄ (preferably, LiPF₆) is preferably used. The electrolytic solution may contain other components. Examples of the other components include a gas-generating agent such as biphenyl (BP) and cyclohexyl benzene (CHB), a film-forming agent, a dispersant, and a thickener.

In a central portion of the wound electrode body 20 in the winding axis X direction, the cathode active material layer 31 and the anode active material layer 41 are laminated, and a core portion in which a charge-discharge reaction is performed is formed. Further, in the wound electrode body 20, at one end portion (left end portion in FIG. 3) in the winding axis X direction, there is a cathode current collector foil laminated portion 33 laminated in a state where the cathode current collector foil exposed portion 32 protrudes from the anode plate 4. In addition, in the wound electrode body 20, there is an anode current collector foil laminated portion in which the anode current collector foil exposed portion is laminated in a state of protruding from the cathode plate 3 at the other end portion in the winding axis X direction (not shown but the right end portion in FIG. 3).

As shown in FIG. 4, the cathode current collector foil exposed portion 32 is integrated with the center portion of the cathode current collector foil laminated portion 33 in the height direction H (hereinafter, referred to as “collector foil”), and the cathode foil combining portion 34 is formed. FIG. 5 is an enlarged view of a part of a cross section of the wound electrode body at the cutting line V in FIG. 4. In FIG. 5, the vicinity of the cathode foil combining portion 34 at the cutting line V as viewed from the upper side (the side of the open arrow) is shown. As shown in FIG. 4, the cathode current collector terminal 16 is electrically connected to the cathode foil combining portion 34 by ultrasonic welding or the like. As shown in FIG. 5, in the cathode foil combining portion 34, since the adjacent cathode current collector foil 30 is collected, no foreign matter enters between the cathode plate 3 and the anode plate 4.

Similarly, in the central portion of the anode current collector foil laminated portion in the height direction H, the anode current collector foil exposed portion is integrated, and the anode foil combining portion is formed. The anode current collector terminal 17 is electrically connected to the anode foil combining portion. In the anode foil combining portion, since the adjacent anode current collector foil is a collector foil, no foreign matter enters between the cathode plate 3 and the anode plate 4.

An insulating layer 35 is formed in at least one of a region of the cathode current collector foil exposed portion 32 excluding the cathode foil combining portion 34 and a region of the anode current collector foil exposed portion excluding the anode foil combining portion. The insulating layer 35 is preferably formed in both a region of the cathode current collector foil exposed portion 32 excluding the cathode foil combining portion 34 and a region of the anode current collector foil exposed portion excluding the anode foil combining portion.

Hereinafter, the insulating layer 35 formed in the cathode current collector foil exposed portion 32 will be described in detail. Since the insulating layer 35 is also formed in the anode current collector foil exposed portion in the same manner as the cathode current collector foil exposed portion 32, a description thereof will be omitted. The insulating layer 35 is, for example, a cured body of a liquid insulating paste. The insulating paste may include, for example, an inorganic material having an insulating property, a solvent for the insulating paste, and a resin component. The inorganic material may be at least one of alumina, bochmite, titania in powder form. As a solvent for insulating pastes, NMP solutions, which are one of organic solvents, are used. The resin component functions as a binder in the insulating layer 35. The polymer component may be at least one selected from the group consisting of PVDF, PVA, and acryl, which are polymer materials soluble in NMP. The insulating layer 35 preferably has flexibility when the cathode current collector foil exposed portion 32 is collected.

As shown in FIG. 3, the insulating layer 35 is formed at predetermined intervals along the long side direction of the cathode current collector foil exposed portion 32. The “predetermined interval” in which the insulating layer 35 is formed is desirably a pitch in which when the cathode plate 3 is wound, the insulating layer 35 is formed over the entire area excluding the cathode foil combining portion 34 of the cathode current collector foil exposed portion 32. The insulating layer 35 is formed on both surfaces of the cathode current collector foil exposed portion 32. Thus, when the wound electrode body 20 is formed by winding the cathode plate 3, the cathode current collector foil 30 is exposed only in the cathode foil combining portion 34.

FIG. 6 is an enlarged view of a part of a cross section of the wound electrode body in the cutting line VI of FIG. 4. FIG. 6 shows the vicinity of the cathode current collector foil laminated portion 33 in the cutting line VI as viewed from the upper side (open arrow side). As shown in FIG. 6, the insulating layer 35 is formed on both surfaces of the cathode current collector foil exposed portion 32 in the cathode current collector foil laminated portion 33.

In general, it is known that metal foreign matters such as welding spatter are generated at the time of manufacturing a battery and enter the inside of the secondary battery 10 through the liquid injection port. The metal foreign matter that has entered into the secondary battery 10 may cause conduction between the battery case 11 and the wound electrode body 20 or between the positive electrode and the negative electrode in the wound electrode body 20, resulting in a short circuit.

Normally, when the electrolytic solution is impregnated, the electrolytic solution permeates into the center of the wound electrode body 20 from the region of the cathode current collector foil laminated portion 33 above and below the cathode foil combining portion 34. When a metal foreign substance that has entered the inside of the secondary battery 10 via the liquid injection port short-circuits the positive electrode and the negative electrode in the wound electrode body 20, a route is conceivable in which the metal foreign substance moves on the flow of the electrolytic solution that penetrates the wound electrode body 20. As a means for preventing a short circuit caused by this route, there is a method of suppressing a metal foreign substance from entering between the positive electrode and the negative electrode.

In JP 2023-089639 A, the outermost separator is extended to join the separator to the positive electrode current collector together with the cathode plate, thereby suppressing intrusion of metal foreign matters. However, by being covered with the separator, the impregnation property of the electrolytic solution may be deteriorated.

In contrast, in the embodiment, the insulating layer 35 is formed in the cathode current collector foil exposed portion 32 in a region excluding the cathode foil combining portion 34. Therefore, even when the metal foreign substance F enters the gap between the cathode plate 3 and the anode plate 4 of the wound electrode body 20 when the electrolytic solution is injected, occurrence of a short circuit can be suppressed. Further, as shown in FIG. 6, in the cathode current collector foil laminated portion 33, since the cathode plate 3 and the separator are not bonded as in JP 2023-089639 A, a gap is formed in the cathode current collector foil laminated portion 33 other than the cathode foil combining portion 34 when the foil is collected. Therefore, it is possible to impregnate the wound electrode body 20 with the electrolytic solution without changing the injection condition of the electrolytic solution.

The present disclosure is not limited to the above-described embodiment, and can be appropriately modified without departing from the spirit thereof.

What is claimed is:

1. A secondary battery comprising:
a wound electrode body in which a cathode plate including a cathode active material layer except for cathode current collector foil exposed portions extending along one long side of a band-shaped cathode current collector foil and an anode plate including an anode active material layer except for anode current collector foil exposed portions extending along one long side of a band-shaped anode current collector foil are wound with a band-shaped separator interposed between the cathode plate and the anode plate;
a battery case that houses the wound electrode body and an electrolytic solution;
a cathode current collector terminal electrically connected to a cathode foil combining portion where the cathode current collector foil exposed portions are combined;
an anode current collector terminal electrically connected to an anode foil combining portion where the anode current collector foil exposed portions are combined; and
insulating layers provided in at least one of regions of the cathode current collector foil exposed portions except the cathode foil combining portion and regions of the anode current collector foil exposed portions except the anode foil combining portion.

2. The secondary battery according to claim 1, wherein the insulating layers are provided at predetermined intervals along a long side direction of the cathode current collector foil or the anode current collector foil.

3. The secondary battery according to claim 1, wherein the insulating layers are provided in both the regions of the cathode current collector foil exposed portions except the cathode foil combining portion and the regions of the anode current collector foil exposed portions except the anode foil combining portion.

4. The secondary battery according to claim 1, wherein:
the separator includes a first separator and a second separator; and
the first separator, the cathode plate, the second separator, and the anode plate are sequentially laid over one another while being aligned in a long side direction, and are wound about a winding axis set along a short side direction.

5. The secondary battery according to claim 4, wherein:
the battery case is a rectangular case having a substantially rectangular parallelepiped outer shape;
the wound electrode body has a flat rectangular parallelepiped outer shape;
the cathode current collector foil exposed portions are stacked while projecting from the anode plate at one end in a direction of the winding axis;
the anode current collector foil exposed portions are stacked while projecting from the cathode plate at the other end in the direction of the winding axis; and
the wound electrode body is housed in the battery case with the direction of the winding axis corresponding to a width direction of the battery case.
